(19) United States
(12) Patent Application Publication
(10) Pub. No.: US 2004/0124838 A1
(43) Pub. Date: Jul. 1, 2004

(54) Wireless detuning of a resonant circuit in an mr imaging system

(76) Inventors: Jeffrey L Duerk, Avon Lake, OH (US); Michael Wendt, Hoboken, NJ (US); Eddy Y Wong, Cleveland Heights, OH (US); Jonathan Lewin, Beachwood, OH (US)

Correspondence Address: Richard J Minnich, Fay Sharpe Fagan Minnich & McKee, 7th Floor, 1100 Superior Avenue, Cleveland, OH, 44114-2518, US

(21) Appl. No.: 10/240,289

(22) PCT Filed: Mar. 30, 2001
(86) PCT No.: PCT/US01/10042

(51) Int. Cl. G01V 3/00

(52) U.S. Cl. 324/304; 324/322

(57) ABSTRACT

An device for use with an MR imaging system emits radio-frequency signals within a first range when acquiring data. A resonant circuit within the device includes a plurality of electrical components. An opto-electronic component within the device electrically communicates with the resonant circuit. The opto-electronic component is controlled to operate in a plurality of modes. The electrical components are not sensitive to the radio-frequency signals within the first range when the opto-electronic component is operating in one of the modes.

This application claims the benefit of U.S. Provisional Application No. 60/193,125, filed Mar. 30, 2000, which is hereby incorporated herein by reference.

### BACKGROUND OF THE INVENTION

The present invention relates in general to nuclear magnetic resonance, and in particular to magnetic resonance (MR) imaging. It finds particular application in conjunction with detuning electrical components, which are sensitive to radio-frequency (RF) signals, within a catheter during an MR procedure and will be described with particular reference thereto. It will be appreciated, however, that the invention is also amenable to other applications in NMR and MRI, including those that are not specifically catheter based.

In interventional MR guided procedures, reliable and accurate visualization of instruments inside the body is essential for procedure success. Current methods for active device tracking involve the use of either single or multiple tuned RF microcoils integrated into the tip of a catheter to provide device position and/or orientation. These microcoils are connected to the MR system through the use of electrical wires (capacitive coupling), which often may also serve both detuning and signal transduction purposes. Separate leads are usually required for individual microcoil detuning and identification. This leads to a cumbersome design in which a multitude of leads may be required for an interventional device and in which patient safety may be compromised due to the potential to establish standing waves, high electric fields on the leads used for detuning, and hence patient tissue heating which is to be avoided.

In MR imaging (MRI) procedures in which tuned local coils are used for signal reception, detuning is also necessary to prevent high voltages from being induced in the receiving coil. These potentially high voltages pose a patient safety hazard (e.g., tissue heating from the RF energy deposited by a MR scanner) and the associated currents will create magnetic fields which disrupt the desired uniform radio-frequency excitation in the patient.

Conventionally, detuning is achieved by applying a voltage to a special portion of the electronics of the receiver coil. The introduction of such a voltage, which requires additional components to be integrated into the circuit, causes the receiver coils sensitivity or resonant frequency to change. In classic active catheter device tracking implementations in interventional MRI (IMRI), active leads, which are used for signal detection and coil detuning, extend the entire length of the catheter to couple the microcoils to an MR scanner. Induced electromagnetic field (EMF) signals from the microcoils are transmitted via insulated wires that are either embedded in the catheter wall or traverse the lumen of the catheter. If careful consideration is not undertaken during the design and placement of these signal wires, there is a possibility of signal corruption from either mutual inductance or stray capacitance. In tracking one or more microcoils, it is necessary to detune all but the coil of interest so that its position may be accurately ascertained without signal interference from the other coils.

Current techniques for detuning coils and coil switching in single or multiple coil systems require the use of additional components such as electrical leads to conduct biasing voltages to active electrical components, which require direct current (DC) voltages to be biased into operation. Alternatively, these biasing voltages can open or close diodes which add or remove inductors or capacitors from the circuit, thereby altering the resonant frequency of the coil. With the addition of these active components, wires for detuning coils and/or coil switching are required. These wires can compromise patient safety by introducing the hazard of electric shock if the device fails during the interventional procedures. Signal wires that extend through the catheter may also act as antennas, converting RF pulses from the MR system into heat and presenting a possible burn hazard.

In addition to signal purity and patient safety concerns, the design of an active, multiple coil system complicates catheter design and construction. For example, physical limits such as the size of the catheter and the number of signal/detuning wires that can be integrated within the lumen of the catheter must be considered. Constraints such as these ultimately limit the number of tracking coils that may be implemented on a catheter.

Prior art in the field of active catheter tracking includes the development and analysis of several different coil designs (e.g., single loop, carrier return, crossed loop and solenoid). The single loop and crossed loop coils have been shown to provide the best signal but worst distortion when oriented parallel to the main magnetic field. Center return coils produce the narrowest linewidth, but have low peak signal. The solenoid coil design does not perform well when oriented parallel to the main magnetic field, but provides the best signal when oriented perpendicular to the main field. In these studies, no detuning methods were employed during the imaging procedure. As discussed above, burn hazards from local heating caused by current flowing in the coil are possible and disruption of the typically desired uniform excitation field will occur.

Another conventional method provides small, untuned single loop integral RF coils that have sensitivities to signals within the radius of the coil (often about 1 mm) and use Hadamard multiplexed pulse sequences to determine location. The problem with this method is that tracking is possible only if a signal is stronger than the background noise level. In addition, if the axis of the receive coil is parallel to the main magnetic field, no current will be induced in the coil and tracking is not possible. One final deficit of the system is that signal loss can occur in regions devoid of MR-active material. Furthermore, no detuning methods are provided.

Another conventional method provides untuned, miniature solenoidal RF coils tuned into tips of catheters. These coils provide the ability to track catheter position and orientation, but employ multiple receiver channels for tracking multiple coils. However, no detuning methods have been employed.

Another conventional method provides tracking coils with internal Gd-DTPA sources. With an internal source, SNR is increased and tracking becomes possible in free space. However, no detuning methods have been implemented.

Another conventional method provides active tip tracking by the use of a thin copper wire wrapped around a catheter and connected to a battery. When current is switched on, a local field inhomogeneity is induced which causes a signal loss. However, issues regarding the electrical safety of actively introducing current into a patient are evident, and precise point-like localization of the device is not possible.

The present invention provides a new and improved apparatus and method that overcomes the above-referenced problems and others.

### SUMMARY OF THE INVENTION

An interventional device for use with an MR imaging system emits radio-frequency signals within a first range when acquiring data. A resonant circuit within the interventional device includes a plurality of electrical components. An opto-electronic component within the interventional device electrically communicates with the resonant circuit. The opto-electronic component is controlled to operate in a plurality of modes. The electrical components are not sensitive to the radio-frequency signals within the first range when the opto-electronic component is operating in one of the modes.

In accordance with one aspect of the invention, the means for controlling the opto-electronic component includes a PIN photodiode.

In accordance with another aspect of the invention, the means for controlling the opto-electronic component includes at least one of a photo-resistor and a photocell.

In accordance with another aspect of the invention, the electrical components in the resonant circuit are electrically connected in parallel.

In accordance with another aspect of the invention, the electrical components in the resonant circuit are electrically connected in series.

In accordance with another aspect of the invention, the means for controlling the opto-electronic component includes a fiber which transmits optical signals.

In accordance with another aspect of the invention, when the opto-electronic component is not operating in the one of the plurality of the modes, the electrical components may be sensitive to the radio-frequency signals within the first range. Also, when the opto-electronic component is operating in the one of the plurality of the modes, the respective ranges of radio-frequency signals to which the electrical components are sensitive are shifted to be outside the first range.

In accordance with another aspect of the invention, when the opto-electronic component is not operating in the one of the plurality of the modes, the electrical components are sensitive to radio-frequency signals, which may be within the first range. Also, when the opto-electronic component is operating in the one of the plurality of the modes, the electrical components are not sensitive to substantially any radio-frequency signals.

In accordance with another aspect of the invention, a second resonant circuit includes a plurality of second electrical components. A second opto-electronic component electrically communicates with the second resonant circuit. The second opto-electronic component is controlled to operate in a plurality of modes. The second electrical components are being sensitive to the radio-frequency signals within the first range when the second opto-electronic component is operating in one of the modes.

In accordance with a more limited aspect of the invention, the interventional device is tracked using time multiplexing.

One advantage of the present invention is that it eliminates the use of electrical detuning leads and, therefore, improves patient safety during interventional MR procedures that selectively track one or catheter-mounted coils which are either inductively coupled or capacitively coupled to the MRI system.

Another advantage of the present invention is that it utilizes a simple but effective circuit, which utilizes an optical scheme, for coil detuning.

Another advantage of the present invention is that it enables detuning for single coil systems without using additional conductive leads.

Another advantage of the present invention is that it may use inductive coupling, which requires no electrical connections for signal reception for tracking signals from microcoils.

Another advantage of the present invention is that it enables localization of each of a plurality of catheter mounted receive coils without requiring complicated active switching circuits.

Still further advantages of the present invention will become apparent to those of ordinary skill in the art upon reading and understanding the following detailed description of the preferred embodiments.

### BRIEF DESCRIPTION OF THE DRAWINGS

The invention may take form in various components and arrangements of components, and in various steps and arrangements of steps. The drawings are only for purposes of illustrating a preferred embodiment and are not to be construed as limiting the invention.

FIG. 1 illustrates an interventional device of the present invention within an MR environment;

FIG. 2 illustrates a first embodiment of the interventional device;

FIG. 3 illustrates an electric circuit representation according to the first embodiment of the present invention;

FIG. 4 illustrates a resonant frequency of an LC circuit when the photo-resistor is not exposed to light;

FIG. 5 illustrates the frequency of FIG. 4 after application of light to the photo-resistor;

FIG. 6 illustrates an electric circuit representation according to a second embodiment of the present invention;

FIG. 7 illustrates a varactor voltage-capacitance curve;

FIG. 8 illustrates another embodiment of the interventional device;

FIG. 9 illustrates an electric circuit representation according to the embodiment illustrated in FIG. 8; and

FIG. 10 illustrates curves showing time multiplexing according to the present invention.

### DETAILED DESCRIPTION OF THE PREFERRED EMBODIMENTS

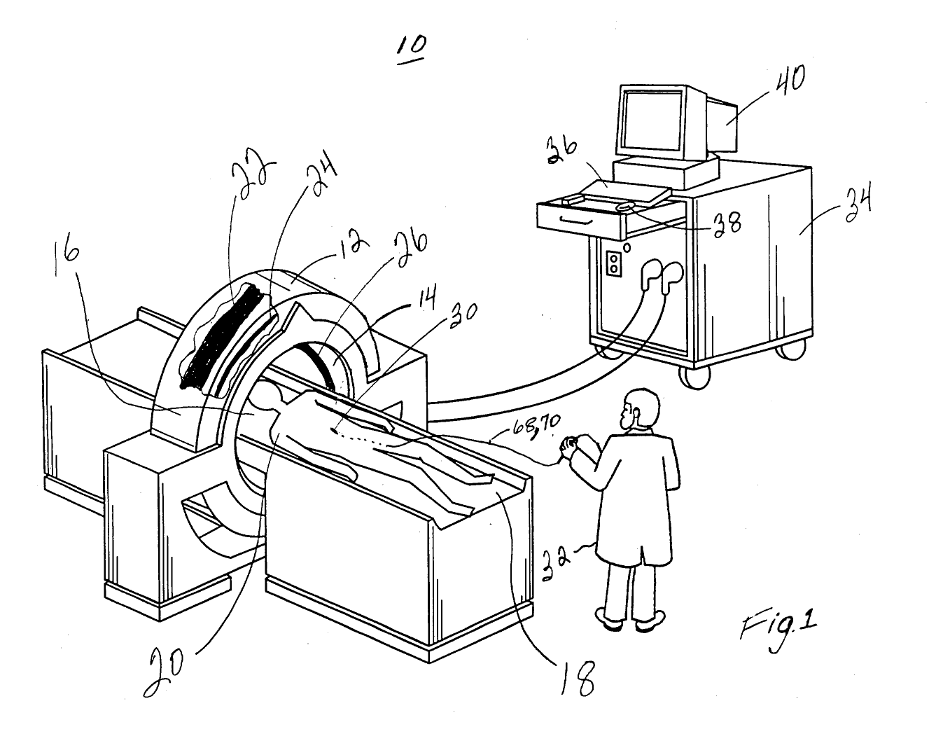

With reference to FIG. 1, an MRI system 10 includes a housing 12 around a horizontal bore 14, which substantially surrounds a region of interest 16 including a support table 18 on which a subject 20 is positioned. A magnet 22 and a set of magnetic field gradient coils 24, which substantially surround the support table 18 and the subject 20, are included in the housing 12. The gradient coils 24 create magnetic field gradients having predetermined strengths, in three mutually orthogonal directions, at predetermined times. A plurality of external coils 26 (only one is shown in FIG. 1) also surround the region of interest 16. The external coils 26 emit a range of radio-frequency (RF) energies (including, for example, about 8.25-85 MHz depending on the field strength of the magnet) into the region of interest 16 and the subject 20 at predetermined times and with sufficient power at a predetermined frequency so as to create an induced signal from nuclear magnetic spins within the subject 20 in a fashion well known to those skilled in the art. The spins resonate at the Larmor frequency, which is directly proportional to the strength of the magnetic field experienced by the spin. This field strength is the sum of the static magnetic field generated by the magnet 22 and the local field generated by the magnetic field gradient coil 24.

FIG. 1 shows one embodiment of an external coil 26 which has a diameter sufficient to encompass the entire subject 20. Other geometries such as smaller external coils (e.g., surface coils) specifically designed for imaging the head or an extremity are also contemplated. The technology described here is applicable to such coils. In our embodiment, we implemented this on coils mounted on catheters that are to be inserted into the subject (interventional coils).

A device 30, which is described in more detail below, is inserted by an operator 32 into a portion of the subject 20 located within the bore 14 (i.e., within a bore of the magnet 22). In the preferred embodiment, the device 30 is a catheter. However, other embodiments in which the device 30 is a guide wire, an endoscope, a laparoscope, a biopsy needle, an external receive coil, etc. are also contemplated.

A processing (computing) device 34 acts as an operator interface for controlling the support table 18, the magnet 22, the magnetic field gradient coils 24, the external coils 26, and the device 30 via one (1) or more input/output devices including, for example, a keyboard 36, a pointing device 38 (e.g., a mouse), and a viewing device 40 (e.g., a monitor having an optional touch-screen). As will be discussed in more detail below, the operator interface 34 receives data from the magnet 22, the magnetic field gradient coils 24, the external coils 26, and the device 30 for providing an image of a position of the device 30 relative to the subject 20.

With reference to FIGS. 1-3, the device 30 contains a resonant circuit 50, which includes a plurality of electrical components. In the preferred embodiment, the resonant circuit 50 is formed from a capacitor (C) 52 and an inductor (L) 54 and has a resonant frequency defined according to:

$$\frac{1}{\sqrt{LC}} .$$

The device 50 also includes an opto-electronic component 56, which electrically communicates with the resonant circuit 50. The opto-electronic component 56 operates in a plurality of modes (e.g., preferably two (2) modes). For example, in a first one of the modes, the opto-electronic component 56 presents a high (e.g., above about 1 MΩ) resistance (i.e., an open-circuit) as sensed by the resonant circuit 50; in a second one of the modes, the opto-electronic component 56 presents substantially zero (0) resistance (e.g., about 34.8 Ω with one device currently on the market) (i.e., nearly a short-circuit) as sensed by the resonant circuit 50.

A fiber optic cable 60 included within the device 30 communicates with the opto-electronic component 56 and the operator interface 34. By transmitting or not transmitting light to the opto-electronic component 56, the fiber optic cable 60 acts as a means for controlling the mode in which the opto-electronic component 56 operates. Light is transmitted to the opto-electronic component 56 via the fiber optic cable 60 according to control commands initiated within the computing device 34.

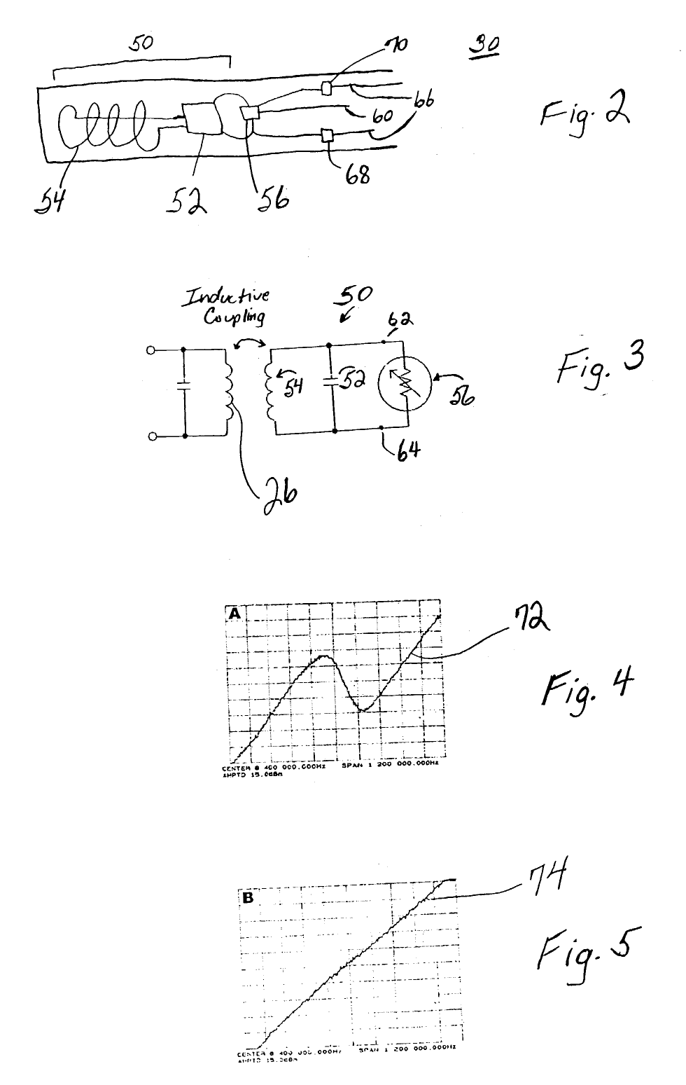

In the embodiment shown in FIG. 3, the opto-electronic device 56 is a photo-resistor electrically connected in parallel with the capacitor 52 and the inductor 54 of the resonant circuit 50. When no light is being transmitted to the opto-electronic device 56 via the fiber optic cable 60, the photo-resistor 56 operates in the first mode and the resistance of the photo-resistor 56 is high enough (e.g., about 1 MΩ) such that the resonant circuit 50 senses an open-circuit across the points 62, 64. Therefore, the inductor and capacitor resonant circuit 50 is sensitive to the range of RF signals emitted by the magnet 22 or the spins, and the MRI signal frequencies induced by the magnetic field gradient coils 24, and the external coils 26. Consequently, the parallel resonant circuit 50 inductively couples with the external coil 26, which also acts as a receiving coil. However, when light is transmitted to the opto-electronic device 56 via the fiber optic cable 60, the photo-resistor 56 operates in the second mode and the resistance of the photo-resistor 56 is low enough (e.g., about 34.8 Ω) such that the resonant circuit 50 senses nearly a short-circuit across the points 62, 64. The short circuit changes the sensitivity of RF signals to which the electric components of the resonant circuit 50 are sensitive. More specifically, the short circuit across 62, 64 causes the electrical components (i.e., the inductor 54 and the capacitor 52) to not be sensitive to the range of RF signals emitted by the magnet 22 or the subject spins, the magnetic field gradient coils 24, and the external coils 26. In other words, the electrical components are detuned and, consequently, are not sensitive to the MR RF frequencies and hence do not inductively couple a significant signal to external coil 26. In FIG. 3, the coil detuning and MRI signal induction is done wirelessly (i.e., without direct electrical connection ) between the catheter coils and the MR system.

With reference again to FIGS. 1 and 2, in the scenario where signal reception is performed via direct (capacitive) coupling with the computing device 34, although the inductor 54 and capacitor 52 is detuned via light signals transmitted along the fiber optic cable 60 to the photo-resistor 56, RF signals are transmitted along electrical wires 66 from the resonant circuit 50 to the computing device 34. The electrical wires 66 are subject to standing waves created by the RF signals and, therefore, pose the same safety risks to the subject 20 as those discussed above for the resonant circuit 50 within the device 30. Therefore, additional opto-electronic components 68, 70 are electrically connected at positions along the wires 66 for changing the electrical lengths of the wires 66 as necessary. When activated, the additional opto-electronic components 68, 70 “cut” the electrical length of the wires 66 to a length such that the wires are not sensitive to the range of RF signals produced by the magnet 22, the magnetic field gradient coils 24, and the external coils 26. In this manner, the safety risks associated with the wires 66, which extend inside the subject 20, are significantly reduced. In FIG. 2, detuning is performed without wires; existing wires used for signal transduction to the MRI system can be “cut” to reduce their length and avoid heating issues via opto-electronic devices. During signal reception, the direct electrical connection is restored through control of the light signal from the user interface to the opto-electronic devices.

FIG. 4 shows a peak depicting the resonant frequency 72 of an LC circuit (see, for example, the circuit 50) when the photo-resistor 56 is not exposed to light. FIG. 5 shows that after application of light to the photo-resistor 56, the peak 72 of FIG. 4 disappears and is replaced by a frequency plot illustrated as 74. The frequency plot without a resonant peak 74 indicates the corresponding circuit is detuned.

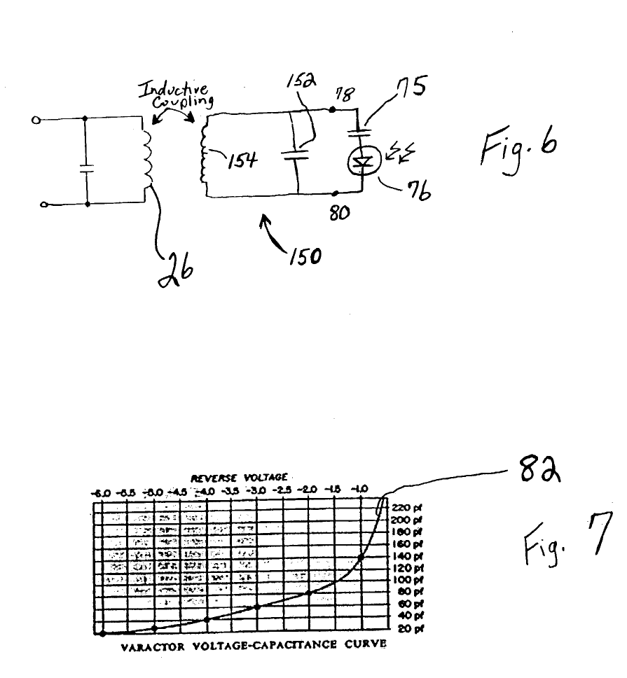

A second embodiment of the present invention is illustrated with reference to FIG. 6. For convenience, components of the embodiment illustrated in FIG. 6, which correspond to the respective components of the embodiment illustrated in FIG. 3, are given numerical references greater by one-hundred than the corresponding components in FIG. 3. New components are designated by new numerals.

With reference to FIGS. 1, 2 and 6, the opto-electronic device 76 is a PIN photodiode electrically connected in series with a detuning capacitor 75 and connected in parallel with the capacitor 152 and the inductor 154 of the resonant circuit 150. When no light is being transmitted to the opto-electronic device 76 via the fiber optic cable 60, the PIN photodiode 76 operates in a first mode and the resistance of the PIN photodiode 76 is high enough such that the resonant circuit 150 senses an open-circuit across the points 78, 80. Therefore, the inductor 154 within the resonant circuit 150 is sensitive to the range of RF signals emitted by the magnet 22, the magnetic field gradient coils 24, and the external coils 26. However, when light is transmitted to the opto-electronic device 76 via the fiber optical cable 60, the PIN photodiode 76 operates in a second mode and the resistance of the pin photodiode is low enough that it switches in the detuning capacitor 75 into the parallel resonant circuit 150. By switching in the detuning capacitor 75 the resonant frequency of the parallel resonant circuit 150 is shifted and the circuit is no longer sensitive to the range of RF signals emitted by the magnet 22, the magnetic field gradient coils 24, and the external coils 26. In other words, the parallel resonant circuit 150 is detuned.

Although the opto-electronic component 56 is illustrated as a photo-resistor or PIN photodiode electrically connected in parallel with a resonant circuit, various other types of electrical configurations (e.g., a photo-resistor or a PIN photodiode connected in series with a resonant circuit, etc.) and other types of opto-electronic devices (e.g., a photocell or a photovoltaic cell) are also contemplated.

A photovoltaic cell is a semiconductor that converts light to electric current. It is a specially constructed diode, usually made of silicon crystal. A voltage variable capacitor or varactor diode is used in conjunction with a photovoltaic cell. Because the capacitance of a varactor diode is proportional to the controlling voltage, the varactor diode can be used to fine tune the resonant frequency of the circuit, where the resonant frequency is given by:

$$\frac{1}{\sqrt{L ( {C}_{fixed} + {C}_{variable} )}} .$$

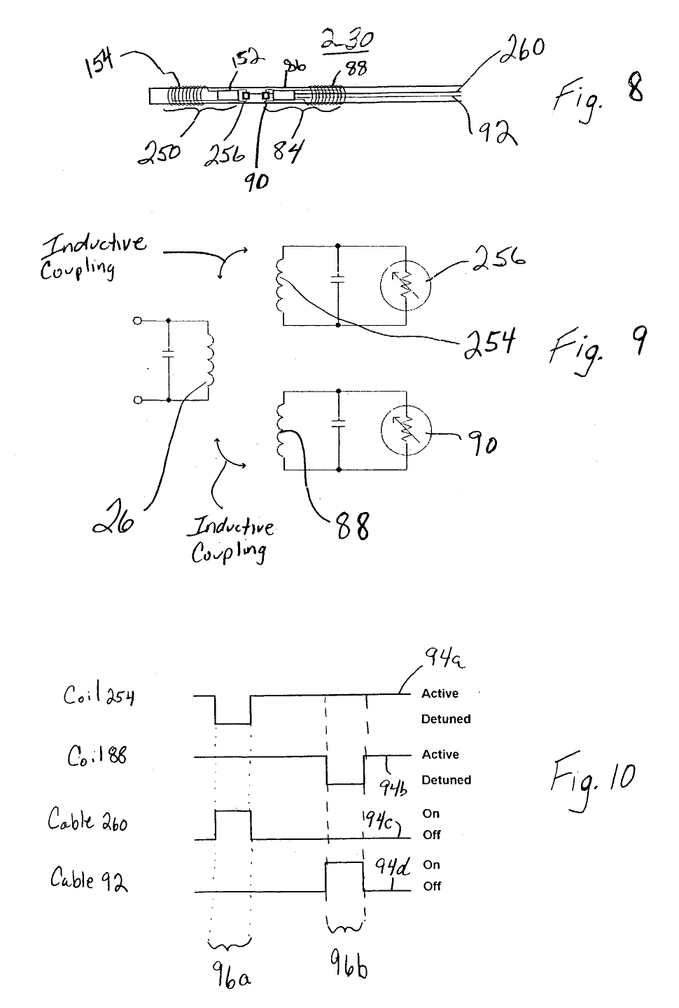

When a reverse voltage is applied to a PN junction, the holes in the p-region are attracted to the anode terminal and electrons in the n-region are attracted to the cathode terminal creating a region where there is little current. This region, the depletion region, is essentially devoid of carriers and behaves as the dielectric of a capacitor. The depletion region increases as reverse voltage across it increases; and since capacitance varies inversely as dielectric thickness, the junction capacitance will decrease as the voltage across the PN junction increases. So by varying the reverse voltage across a PN junction, the junction capacitance can be varied. This is shown in the typical varactor voltage-capacitance curve 82 of FIG. 7.

The device is constructed such that the varactor diode is placed in parallel with the existing parallel resonant circuit. The varactor diode may also replace the existing capacitors of the circuit if conditions permit. The varactor diode is connected to the photovoltaic cell and generates the necessary voltages to vary the capacitance of the diode to allow for either fine-tuning of the resonant frequency or inducing a large frequency shift and this detuning the circuit. An optic fiber is used to deliver light to the photovoltaic cell. The light intensity is modulated to modulate the tuning voltage.

A third embodiment of the present invention is illustrated with reference to FIG. 8. For convenience, components of the embodiment illustrated in FIG. 8, which correspond to the respective components of the embodiment illustrated in FIG. 3, are given numerical references greater by two-hundred than the corresponding components in FIG. 3. New components are designated by new numerals.

With reference to FIG. 8, the device 230 contains a plurality of resonant circuits 250, 84, each of which includes a plurality of electrical components. Although FIG. 8 only shows two resonant circuits, it is contemplated to have twenty or more. More specifically, the resonant circuit 250 is formed from an RF coil including a capacitor 252 and an inductor 254; the resonant circuit 84 is formed from an RF coil including a capacitor 86 and an inductor 88. The inductor 88 acts as a winding within the RF coil 84. The device 230 also includes two (2) opto-electronic components 256, 90, each of which electrically communicates with the resonant circuit 250, 84, respectively. As discussed above, the opto-electronic components 256, 84 preferably operate in two (2) modes. Respective fiber optic cables 260, 92 communicate with the devices 256, 90 and the computing device 34.

With reference to FIGS. 1 and 8-10, the external coil 26 is capable of inductively coupling with the inductors 254, 88 in the device 230. Because two resonant circuits are included in the device 230, it is possible to also determine both the position and orientation of the device 230, in addition to their possible use as imaging coils. (Since the device 30 of FIG. 2 only includes a single inductor 54, only the position of the device 30 may be determined.) Furthermore, if the interrogation of the parallel resonant circuits 250, 84 and the external coil 26 is time multiplexed, it is also possible to determine the direction (trajectory) of the device 230. This coupling is modulated by detuning the coils independently.

Time multiplexing is controlled by the computing device 34, which causes control signals (i.e., light) to be transmitted along the fiber optic cables 260, 92 to the opto-electric components 256, 90. More specifically, the curves 94a, 94b, 94c, 94d of FIG. 10 show that the control signal (light) is transmitted along the fiber optic cable 260 to detune the inductive coil 254 during a first time period 96a. During the first time period 96a, the circuit, including the inductive coil 88 is active and, therefore, inductively couples with the external coil 26. Then, the control signal (light) is transmitted along the fiber optic cable 92 to detune the resonant circuit, including the inductive coil 88 during a second time period 96b. During the second time period 96b, the resonant circuit, including the inductive coil 254 is active and, therefore, inductively couples with the inductive coil 26. Alternatively, a single multi-element optical fiber could be used and light of different wavelengths used to select which optoelectric device is activated, provided the light wavelengths match that of the devices. Multiple methods to change the wavelength sensitivity of the opto-electronic devices are known to those practicing in this field.

Once the position of the device 30 or the position and orientation of the device 230 is determined, a graphic symbol of the device 30, 230 is superimposed on a conventional MR diagnostic image via the viewing device 40. A series of successive images including the superimposed device is used for tracking a path of the device 30, 230 in the subject 20 or generating an image from the device at its current position, or receiving a signal from which spectroscopic analysis can be performed.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiment, the invention is now claimed to be:

1. An device for use with an MR imaging system which detects and emits radio-frequency signals within a first range when acquiring data, the device comprising:
a resonant circuit including a plurality of electrical components;
an opto-electronic component electrically communicating with the resonant circuit; and
means for controlling the opto-electronic component to operate in a plurality of modes, the electrical components not being sensitive to the radio-frequency signals within the first range when the opto-electronic component is operating in one of the modes.

2. The device use with an MR imaging system as set forth in claim 1, wherein the opto-electronic component includes:
a PIN photodiode.

3. The device use with an MR imaging system as set forth in claim 1, wherein the opto-electronic component includes:
at least one of a photo-resistor and a photocell.

4. The device use with an MR imaging system as set forth in claim 1, wherein the electrical components in the resonant circuit are electrically connected in parallel.

5. The device use with an MR imaging system as set forth in claim 1, wherein the electrical components in the resonant circuit are electrically connected in series.

6. The device for use with an MR imaging system as set forth in claim 1, wherein the means for controlling the opto-electronic component includes:
a fiber which transmits optical signals.

7. The device for use with an MR imaging system as set forth in claim 1, wherein:
when the opto-electronic component is not operating in the one of the plurality of the modes, the electrical components may be sensitive to the radio-frequency signals within the first range;
when the opto-electronic component is operating in the one of the plurality of the modes, the respective ranges of radio-frequency signals to which the electrical components are sensitive are shifted to be outside the first range.

8. The device for use with an MR imaging system as set forth in claim 1, wherein:
when the opto-electronic component is not operating in the one of the plurality of the modes, the electrical components are sensitive to radio-frequency signals, which may be within the first range; and
when the opto-electronic component is operating in the one of the plurality of the modes, the electrical components are not sensitive to substantially any radio-frequency signals.

9. The device for use with an MR imaging system as set forth in claim 1, further including:
a second resonant circuit including a plurality of second electrical components;
a second opto-electronic component electrically communicating with the second resonant circuit; and
means for controlling the second opto-electronic component to operate in a plurality of modes, the second electrical components not being sensitive to the radio-frequency signals within the first range when the second opto-electronic component is operating in one of the modes.

10. The device for use with an MR imaging system as set forth in claim 9, further including:
a time multiplexing means for one of tracking the device and selecting which one of the coils to use for signal reception.

11. A method of controlling an device for use with an MR imaging system which emits radio-frequency signals within a first range when acquiring data, the method comprising:
determining if it desirable to detune a resonant circuit within the device from the radio-frequency signals within the first range; and
if it desirable to detune the resonant circuit, controlling an opto-electronic component, which is within the device, to operate in a control mode causing electrical components within the resonant circuit to substantially not be sensitive to the radio-frequency signals within the first range.

12. The method of controlling an device as set forth in claim 11, wherein the controlling step includes:
transmitting a light signal to the opto-electronic component via a fiber optic within the device.

13. The method of controlling an device as set forth in claim 11, further including:
shifting a range of RF signals to which the resonant circuit is sensitive when the opto-electronic component operates in the control mode.

14. The method of controlling an device as set forth in claim 11, further including:
reducing the sensitivity of the resonant circuit to any RF signals.

15. The method of controlling an device as set forth in claim 11, further including:
determining if it desirable to detune a second resonant circuit within the device from the radio-frequency signals within the first range; and
if it desirable to detune the second resonant circuit, controlling a second opto-electronic component, which is within the device, to operate in a control mode causing second electrical components within the second resonant circuit to substantially not be sensitive to the radio-frequency signals within the first range.

16. The method of controlling an device as set forth in claim 15, further including:
one of tracking and selectively receiving the device within the MR imaging system via time multiplexing.

17. A system for detuning electrical components used within an MR environment, comprising:
a magnet for creating a magnetic field within an area of interest;
a plurality of gradient coils for creating magnetic field gradients in the area of interest;
a plurality of external coils for emitting a range of radio-frequency signals into the region of interest;
an device including a coil;
an opto-electronic component electrically communicating with the coil; and
means for toggling the opto-electronic component between causing the coil to be sensitive and not sensitive to the radio-frequency signals emitted by the external coil.

18. The system for detuning electrical components as set forth in claim 17, wherein the device includes:
a second coil;
a second opto-electronic component electrically communicating with the second coil; and
means for toggling the second opto-electronic component between causing the second coil to be sensitive and not sensitive to the radio-frequency signals emitted by the external coil.

19. The system for detuning electrical components as set forth in claim 18, further including:
means for one of tracking and selectively imaging from the device coils by alternately toggling the opto-electronic components for alternately causing the one of the coils to be sensitive to the radio-frequency signals while the other of the coils is not sensitive to the radio-frequency signals.

20. The system for detuning electrical components as set forth in claim 17, wherein the means for toggling includes:
a fiber optic cable capable of transmitting light to the opto-electric components.
